(19) United States
(12) Patent Application Publication
(10) Pub. No.: US 2026/0147684 A1
(43) Pub. Date: May 28, 2026

(54) INFORMATION PROCESSING APPARATUS AND CONTROL METHOD

(71) Applicant: Lenovo (Singapore) Pte. Ltd., Singapore (SG)

(72) Inventors: Atsunobu Nakamura, Kanagawa (JP); Tsutomu Chonan, Kanagawa (JP); Atsushi Ohyama, Kanagawa (JP)

(73) Assignee: Lenovo (Singapore) Pte. Ltd., Singapore (SG)

(21) Appl. No.: 19/178,363

(22) Filed: Apr. 14, 2025

(30) Foreign Application Priority Data
Jun. 4, 2024 (JP) 2024-090680

(51) Int. Cl. G06F 11/30; G06F 1/26

(52) U.S. Cl. CPC G06F 11/3058; G06F 1/26

(57) ABSTRACT

An information processing apparatus includes: a temperature sensor that detects an ambient temperature; and a computer system that controls power consumption based on thermal design power corresponding to the ambient temperature. There are predetermined first thermal design power that is thermal design power corresponding to an optimum temperature, and second thermal design power that is thermal design power corresponding to an upper limit of an operating temperature to be less than the first thermal design power. When the ambient temperature is higher than the optimum temperature and lower than the upper limit of the operating temperature, the computer system determines the thermal design power to be less than or equal to the first thermal design power and to be convex upward with respect to the ambient temperature.

### CROSS-REFERENCE TO RELATED APPLICATIONS

This application claims priority to Japanese Patent Application No. 2024-090680 filed on June 4, 2024, the contents of which are hereby incorporated herein by reference in their entirety.

### TECHNICAL FIELD

The present application relates to an information processing apparatus and a control method, and more particularly to, for example, power management in a computer system.

### BACKGROUND

In the field of personal computers (PC), processors typically generate heat at a level correlated to performance.

There is room for improvement in this field with respect to power management in the context of operating temperatures.

The performance of a processor may not be fully demonstrated at the thermal design power (TDP) that has been preset in the processor. For example, in the case where the TDP is set to decrease in response to an increase in ambient temperature when the ambient temperature exceeds the optimum temperature, the processing power of the processor may fluctuate unexpectedly when the ambient temperature fluctuates in a temperature range higher than the optimum temperature. In addition, even within the same product series, the placement, performance, capacity, and other detailed specifications of the members of the information processing apparatus may differ depending on the stock-keeping unit (SKU). In the case where common settings are applied to different SKUs, there may be differences in processing power for each SKU. In situations where high processing power is required, there is a tendency for the phenomenon of performance not being demonstrated to become apparent.

### SUMMARY

An information processing apparatus according to one or more embodiments of the present application includes: a temperature sensor that detects an ambient temperature; and a computer system that controls power consumption based on thermal design power corresponding to the ambient temperature, wherein there are predetermined first thermal design power that is thermal design power corresponding to an optimum temperature and second thermal design power that is thermal design power corresponding to an upper limit of an operating temperature to be less than the first thermal design power and wherein, when the ambient temperature is higher than the optimum temperature and lower than the upper limit of the operating temperature, the computer system determines the thermal design power to be less than or equal to the first thermal design power and to be convex upward with respect to the ambient temperature.

In the above information processing apparatus, an intermediate temperature higher than the optimum temperature and lower than the upper limit of the operating temperature may be predetermined, third thermal design power that is thermal design power corresponding to the intermediate temperature may be predetermined so that a percentage change from the first thermal design power corresponding to the optimum temperature is less than a percentage change from the first thermal design power corresponding to the optimum temperature to the second thermal design power, when the ambient temperature is higher than the optimum temperature and lower than the intermediate temperature, the computer system may subtract a product of a percentage change in difference between the first thermal design power and the third thermal design power for a difference in temperature between the optimum temperature and the ambient temperature and the difference in temperature between the optimum temperature and the ambient temperature from the first thermal design power to determine the thermal design power for the ambient temperature, and when the ambient temperature is higher than the intermediate temperature and lower than the upper limit of the operating temperature, the computer system may subtract a product of a percentage change in difference between the third thermal design power and the second thermal design power for a difference in temperature between the intermediate temperature and the upper limit of the operating temperature and a difference in temperature between the intermediate temperature and the ambient temperature from the third thermal design power to determine the thermal design power for the ambient temperature.

In the above information processing apparatus, the third thermal design power may be equal to the first thermal design power.

The information processing apparatus described above may further include a second temperature sensor that detects a surface temperature. Further, there may be predetermined a first target surface temperature that is a target surface temperature corresponding to the optimum temperature and a second target surface temperature that is a target surface temperature corresponding to the upper limit of the operating temperature to be higher than the first target surface temperature. Still further, the computer system may determine the target surface temperature to be higher than or equal to the first target surface temperature and to be convex downward with respect to the ambient temperature when the ambient temperature is higher than the optimum temperature and lower than the upper limit of the operating temperature.

In the above information processing apparatus, an intermediate temperature higher than the optimum temperature and lower than the upper limit of the operating temperature is predetermined. Further, the third target surface temperature that is a target surface temperature corresponding to the intermediate temperature is predetermined so that the percentage change from the first target surface temperature corresponding to the optimum temperature is greater than the percentage change from the first target surface temperature corresponding to the optimum temperature to the second target surface temperature corresponding to the upper limit of the operating temperature. Still further, the computer system may add a product of a percentage change in difference between the first target surface temperature and the third target surface temperature for a difference in temperature between the optimum temperature and the intermediate temperature and a difference in temperature between the optimum temperature and the ambient temperature to the first target surface temperature to determine the target surface temperature for the ambient temperature, when the ambient temperature is higher than the optimum temperature and lower than the intermediate temperature. The computer system may add a product of a percentage change in difference between the third target surface temperature and the second target surface temperature for a difference in temperature between the intermediate temperature and the upper limit of the operating temperature and a difference in temperature between the intermediate temperature and the ambient temperature to the third target surface temperature to determine the target surface temperature for the ambient temperature, when the ambient temperature is higher than the intermediate temperature and lower than the upper limit of the operating temperature.

In the information processing apparatus, the third target surface temperature may be equal to the first target surface temperature.

In the information processing apparatus described above, the computer system may operate in any one of multiple-step operating modes with different rated power and may determine the thermal design power to be less than or equal to the first thermal design power and to be convex upward with respect to the ambient temperature, when operating in an operating mode where the rated power is greater than predetermined reference power and the ambient temperature is higher than the optimum temperature and lower than the upper limit of the operating temperature.

A control method according to one or more embodiments of the present application is a control method in an information processing apparatus including a temperature sensor that detects an ambient temperature and a computer system that controls power consumption based on thermal design power corresponding to the ambient temperature, wherein: there are predetermined first thermal design power that is thermal design power corresponding to an optimum temperature and second thermal design power that is thermal design power corresponding to an upper limit of an operating temperature to be less than the first thermal design power; and when the ambient temperature is higher than the optimum temperature and lower than the upper limit of the operating temperature, the thermal design power is determined to be less than or equal to the first thermal design power and to be convex upward with respect to the ambient temperature.

One or more embodiments of the present application can provide the performance of the information processing apparatus while suppressing heat generation.

### BRIEF DESCRIPTION OF THE DRAWINGS

FIG. 1 is a schematic block diagram illustrating an example of a hardware configuration of an information processing apparatus according to one or more embodiments.

FIG. 2 is a schematic block diagram illustrating an example of a functional configuration of the information processing apparatus according to one or more embodiments.

FIG. 3 is a diagram illustrating power control parameters and drive parameters according to one or more embodiments.

FIG. 4 is an explanatory diagram illustrating an example of setting a target TDP and a target surface temperature according to one or more embodiments.

FIG. 5 is a diagram illustrating the time variation of the target TDP according to one or more embodiments.

FIG. 6 is a diagram illustrating the time variation of a target surface temperature according to one or more embodiments.

FIG. 7 is a diagram illustrating a benchmark test execution result.

### DETAILED DESCRIPTION

The following describes embodiments of the present application with reference to the drawings.

First, an overview of an information processing apparatus 1 according to one or more embodiments of the present application is described. In the following description, it is mainly assumed that the information processing apparatus 1 is a personal computer (PC). The information processing apparatus 1 is not necessarily limited to a PC, but may be configured as an information processing apparatus having other forms, such as a smart phone, a tablet terminal device, and the like.

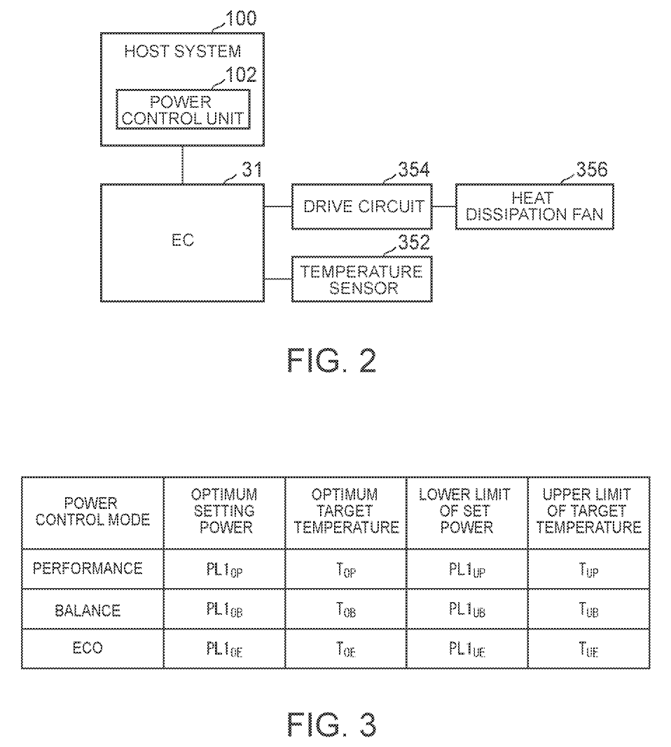

The information processing apparatus 1 has a temperature sensor 352 and a host system 100 (FIG. 2). The temperature sensor 352 detects an ambient temperature. The host system 100 controls the power consumption thereof, based on the thermal design power (TDP) corresponding to the ambient temperature. Control parameters are set in the host system 100 to control the power consumption with thermal protection. In general, the information processing apparatus 1 has an operating temperature range and an optimum temperature, which have been set. In the host system 100, first thermal design power and second thermal design power are set in association with the optimum operating temperature and the maximum operating temperature. The host system 100 determines thermal design power to be less than or equal to the first thermal design power and to be convex upward with respect to the ambient temperature when the ambient temperature is higher than the optimum temperature and lower than the upper limit of the operating temperature.

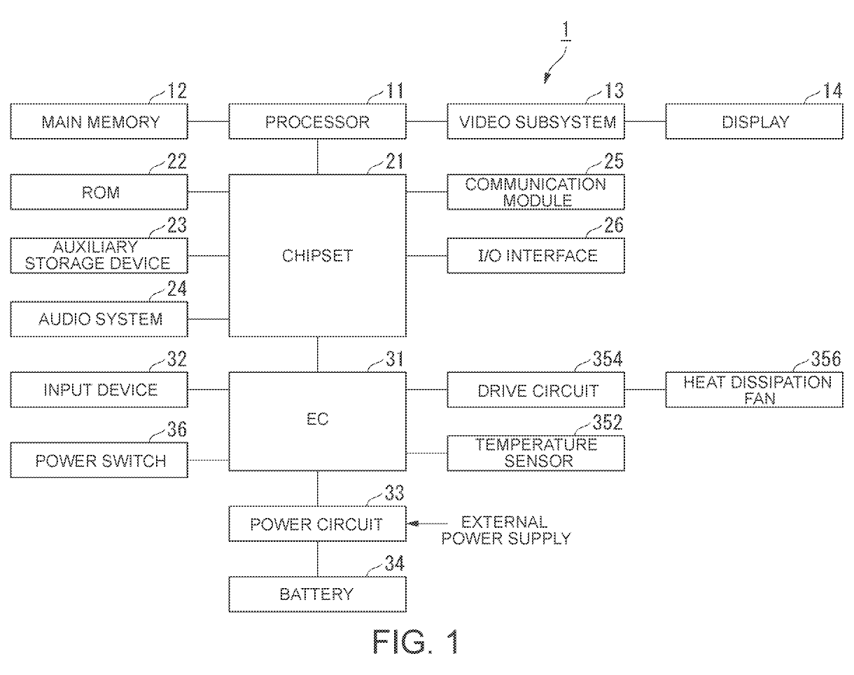

FIG. 1 is a schematic block diagram illustrating an example of the hardware configuration of the information processing apparatus 1 according to one or more embodiments. The information processing apparatus 1 includes a processor 11, a main memory 12, a video subsystem 13, a display 14, a chipset 21, a read only memory (ROM) 22, an auxiliary storage device 23, an audio system 24, a communication module 25, an input/output interface 26, an embedded controller (EC) 31, an input device 32, a power circuit 33, a battery 34, temperature sensors 352 and 353, a drive circuit 354, a heat dissipation fan 356, and a power switch 36.

The processor 11 is a core processing apparatus that performs various arithmetic operations as instructed by instructions described in software (program). Processes performed by the processor 11 include writing or reading data to or from storage media such as the main memory 12 and the auxiliary storage device 23, and input or output to or from other devices. The processor 11 includes at least one CPU. The CPU controls the operation of the entire information processing apparatus 1. The CPU performs processes based on programs, such as an operating system (OS), firmware, a device driver, a utility, and an application program (sometimes referred to as “app” in the present application). Performing a process specified by commands written in various programs is sometimes referred to as “executing a program,” “execution of a program,” or the like.

The main memory 12 is a writable memory that is used as a read area for the execution program of the processor 11 or as a work area for writing processing data of the execution program. The main memory 12 is, for example, composed of multiple dynamic random access memory (DRAM) chips. The processor 11 and the main memory 12 correspond to the minimum hardware that makes up the host system 100 (FIG. 2). The host system is the computer system that forms the core of the information processing apparatus 1.

The video subsystem 13 is a subsystem for implementing functions related to image display, and includes a video controller. The video controller processes drawing instructions from the processor 11, writes resulting drawing information to a video memory, and reads the drawing information from the video memory and then outputs the drawing information to the display 14 as display data indicating display information (image processing). The video subsystem 13 may be configured to include one or more graphic processing units (GPUs) or co-processors. The GPU is a processor that mainly handles real-time image processing and other parallel arithmetic operations. The GPU may share some processes with the CPU. The GPU may be integrated with the CPU, functioning as the processor 11, and be formed on the same core, or the GPU may be formed on a separate core from the CPU. The GPU may also perform parallel arithmetic operations other than image processing, or may share some processes with the CPU.

The display 14 displays a display screen based on display data that is input from the video subsystem 13. The display 14 may be any of, for example, a liquid crystal display (LCD), an organic light emitting diode (OLED) display, and the like.

The chipset 21 has a plurality of controllers and is allowed to be connected to a plurality of devices in such a way as to be able to input and output various data to and from the devices. The chipset 21 is configured to include any one or a combination of bus controllers such as, for example, a universal serial bus (USB), a serial AT attachment (ATA), a serial peripheral interface (SPI) bus, a peripheral component interconnect (PCI) bus, a PCI-Express bus, and a low pin count (LPC). The connected devices include the ROM 22, the auxiliary storage device 23, the audio system 24, the communication module 25, the input/output interface 26, and the EC 31.

The ROM 22 mainly stores firmware. The firmware stored in the ROM 22 may include system firmware for the host system 100 and firmware for controlling the operations of the EC 31 and other devices. The ROM 22 may be, for example, either electrically erasable programmable read only memory (EEPROM) or a flash ROM.

The auxiliary storage device 23 stores various data used in the processing of the processor 11 and other devices, various data acquired by such processing, various programs, and the like. The auxiliary storage device 23 may be any one or a combination of a solid state drive (SSD), a hard disk drive (HDD), and the like.

The audio system 24 is connected to a microphone and a speaker (not illustrated), and performs recording, playback, and output of audio data. The microphone and the speaker may be built into or attached to the chassis of the information processing apparatus 1, or may be separate from the information processing apparatus 1.

The communication module 25 connects to a communication network via wireless or wired communication. The communication module 25 communicates various data with other devices connected to the communication network. The communication module includes, for example, a wireless local area network (LAN) that enables various data to be sent and received between devices in accordance with a predetermined wireless communication method (for example, IEEE802.11). In wireless LAN, communication between devices is performed via an access point.

The input/output interface 26 is connected to various devices such as peripheral devices via wired or wireless communication. The input/output interface 26 is, for example, a connector for inputting and outputting data via a wired connection in accordance with USB specifications.

The EC 31 is a one-chip microcomputer that monitors and controls various devices (a peripheral device, a sensor, and the like) regardless of the operating state of the system of the information processing apparatus 1. The EC 31 has a CPU, a ROM, a RAM, multi-channel A/D (analog-to-digital) input pins, D/A (digital-to-analog) output pins, a timer, and digital input/output pins (not illustrated) that are separate from the processor 11. In the example of FIG. 1, the input device 32, the power circuit 33, the temperature sensors 352 and 353, the drive circuit 354, and the power switch 36 are connected to the input/output pins of the EC 31.

The input device 32 detects a user’s operation and outputs an operation signal corresponding to the detected operation to the EC 31. The input device 32 includes any combination of, for example, a keyboard, a touch pad, and the like. The input device 32 may be a touch sensor and may overlap with the display 14 and be configured as a touch panel.

The power circuit 33 converts the voltage of the direct current power supplied from the external power supply or the battery 34 to the voltage required for the operations of respective devices that constitute the information processing apparatus 1, and supplies electric power having the converted voltage to the device, to which the electric power is supplied. The power circuit 33 performs the power supply according to the control of the EC 31. The power circuit 33 has a converter that converts the voltage of the electric power supplied to the converter and a power feeder that charges the battery 34 with the electric power whose voltage has been converted. The power feeder charges the battery 34 with the electric power that remains because of not being consumed by each device from the electric power supplied from the external power supply. When electric power is not supplied from the external power supply, or when the electric power supplied from the external power supply is insufficient, the electric power discharged from the battery 34 is supplied to each device as operating power.

The battery 34 charges or discharges electric power using the power circuit 33. The battery 34 may be any type of battery such as, for example, a lithium-ion battery or a sodium-ion battery.

The temperature sensors 352 and 353, the drive circuit 354, and the heat dissipation fan 356 constitute a heat dissipation unit that dissipates the heat generated in the respective devices.

The temperature sensor 352 detects an ambient temperature and outputs an ambient temperature signal indicating the detected ambient temperature to the EC 31. The ambient temperature corresponds to the operating temperature, which is an element of the operating environment of the information processing apparatus 1. The temperature sensor 352 is installed, for example, on a surface of the chassis of the information processing apparatus 1, in a location that is isolated from the heat emitted by each member (in particular, the processor 11), or in a location that faces an opening and allows air to flow in from the outside of the chassis.

The temperature sensor 353 detects a surface temperature (skin temperature or surface temperature) and outputs a surface temperature signal indicating the detected surface temperature to the EC 31. The temperature sensor 353 is installed in a predetermined location on the chassis surface. The predetermined location to be selected may be a location where a temperature rise caused by heat generation of a member (particularly, the processor 11) provided in the information processing apparatus 1 is prominently apparent, or a location where there is a high possibility of continuous contact with the user’s body. In the case where the information processing apparatus 1 is a laptop-type PC, the temperature sensor 353 is, for example, installed in the center of the bottom surface of the chassis.

The drive circuit 354 supplies the electric power supplied thereto from the power circuit 33 to the heat dissipation fan 356 according to the control of the EC 31. This controls the operation of the heat dissipation fan 356. The heat dissipation fan 356 dissipates the heat generated in the information processing apparatus 1. The heat dissipation fan 356 has a motor that rotates the fins (blades) by consuming the electric power supplied from the drive circuit 354, and draws air into the chassis of the information processing apparatus 1. The air that is drawn in is discharged out of the chassis after exchanging heat with the various parts of the information processing apparatus 1.

Each time a press operation is accepted, the power switch 36 is controlled to either power ON or power OFF as the power supply status for the entire information processing apparatus 1. When the press operation is accepted, the power switch 36 outputs a press signal indicating the press operation to the EC 31. When the information processing apparatus 1 is powered off and a press signal is input from the power switch 36, the EC 31 causes the power circuit 33 to start supplying electric power to each device of the information processing apparatus 1 (power ON). When the processor 11 detects that power supply thereto has started, the processor 11 reads system firmware from the ROM 22, loads the system firmware into the main memory 12, and performs a startup process (boot) according to the commands described in the system firmware. During the startup process, the processor 11 loads data that has been saved to the auxiliary storage device 23 into the main memory 12. Thereafter, the processor 11 starts the OS, and after the OS startup is complete, the processor 11 starts execution of device drivers related to the control of the devices such as the auxiliary storage device 23, the communication module 25, and the input/output interface 26.

On the other hand, when electric power is supplied to the information processing apparatus 1 and a press signal is input from the power switch 36, the EC 31 causes the processor 11 to perform a stop process (shutdown). In the stop process, the processor 11 saves data that is present in the work area at that time to the auxiliary storage device 23. After the data has been saved, the processor 11 stops the processing being performed by applications, device drivers, and other programs that are running at that time. Thereafter, the processor 11 notifies the EC 31 that the stop process has been completed. The EC 31 then causes the power circuit 33 to stop supplying power to the respective devices of the information processing apparatus 1.

The following describes an example of the functional configuration of the information processing apparatus 1 according to one or more embodiments. FIG. 2 is a schematic block diagram illustrating an example of the functional configuration of the information processing apparatus 1 according to one or more embodiments.

The information processing apparatus 1 has a host system 100.

The host system 100 executes various programs using the processor 11, and implements the functions in cooperation with hardware such as the main memory 12, the chipset 21, the input/output interface, and the EC 31.

The host system 100 is a computer system that executes the OS and manages the execution of other programs such as apps, manages computing resources such as a memory and processes, and manages input/output with each device. The host system 100 is connected to the temperature sensor 352 via the EC 31. The host system 100 has a power control unit 102. The power control unit 102 operates according to any one of the predetermined multiple-step power control modes. A power control parameter is set in the register of the processor 11 for each power control mode.

The power control unit 102 may select a power control mode indicated by an operation signal input from the input device 32 in response to a user operation, or may select a power control mode that satisfies the power consumption of the processing in response to the change trend of the power consumption of the processor 11 or to the application program being executed. The power control unit 102 notifies the EC 31 of the selected power control mode.

The power control parameter includes, for example, a first power limit (PL1: Power Limit 1). The PL1 corresponds to rated power. The rated power is a threshold value that allows the moving average of power consumption of the processor 11 to temporarily exceed the value, but restricts the moving average from exceeding this value on a regular basis (for example, continuously for several seconds to tens of seconds or more). The window length (for example, the observation period for the moving average of power consumption) for the moving average is typically around one to ten seconds. The power control parameter may also include a second power limit (PL2: Power Limit 2). PL2 is a threshold value that limits power consumption to exceed the value, even temporarily. In general, the higher the clock frequency, the more arithmetic operations the processor 11 performs, and the higher the power consumption. The processor 11 has a control mechanism that adjusts the clock frequency, for example, so that the instantaneous value of power consumption does not exceed PL2 and the moving average of power consumption does not exceed PL1.

The power control parameters related to thermal protection include optimum setting power and maximum temperature setting power of the processor 11. The optimum setting power corresponds to the rated power that is applied when the ambient temperature is the optimum temperature and the surface temperature is equal to or greater than the target temperature. The optimum setting power corresponds to the target TDP corresponding to the optimum temperature. In the present application, the target temperature related to the surface temperature is sometimes referred to as “target surface temperature.” The optimum temperature is a temperature that is optimal for the operation of the information processing apparatus 1. The optimum temperature is, for example, 15 to 25°C. The maximum temperature setting power corresponds to the rated power that is applied when the ambient temperature is the maximum operating temperature and the surface temperature is equal to or greater than the target surface temperature. The maximum temperature setting power corresponds to the target TDP corresponding to the maximum operating temperature. The maximum operating temperature is the upper limit of the operating temperature. The operating temperature means a temperature range in which the use of the information processing apparatus 1 is recommended. Generally, outside the operating temperature range, member degradation is more significant than in the operating temperature, and the risk of a failure or a malfunction is high, and therefore the use of the information processing apparatus 1 is not recommended. For example, the operating temperature is 0 to 35°C. In addition, the maximum temperature setting power is usually smaller than the optimum setting power.

The power control unit 102 determines the power control parameter on the basis of the ambient temperature notified of by the temperature sensor 352 and the surface temperature notified of by the temperature sensor 353, and controls the operation of the processor 11 using the determined power control parameter.

When the ambient temperature is equal to or lower than the optimum temperature, the power control unit 102 determines the optimum setting power as the target TDP. When the ambient temperature is higher than the optimum temperature and lower than the maximum operating temperature, the power control unit 102 determines the target TDP so as to be less than or equal to the optimum setting power and to be convex upward with respect to the ambient temperature. In other words, when the ambient temperature is higher than the optimum temperature and lower than the maximum operating temperature, the target TDP is a continuous function that takes the ambient temperature as an input value and is determined using a function that gives, as an output value, a function value that is less than the percentage change in power consumption from the optimum setting power to the maximum temperature setting power for a temperature change from the optimum temperature to the maximum operating temperature.

When the surface temperature is lower than the target surface temperature, the power control unit 102 operates the processor 11 according to the power control parameter corresponding to the power control mode at that time.

When the surface temperature is greater than or equal to the target surface temperature, the power control unit 102 notifies the processor 11 of the target TDP at that time, and controls the clock frequency so that the moving average of the power consumption does not exceed the target TDP for several seconds to tens of seconds on a continuing basis.

The target surface temperature may be a constant value for each power control mode, a constant value regardless of the power control mode, or variable depending on the ambient temperature. The power control parameter may also include the optimum target temperature and the target temperature upper limit. The optimum target temperature is the target value for the surface temperature corresponding to the optimum temperature. The target temperature upper limit is the target value for the surface temperature corresponding to the maximum operating temperature. The target temperature upper limit is set to be higher than the optimum target temperature.

The power control unit 102 determines the target surface temperature corresponding to the ambient temperature on the basis of the optimum target temperature and the target temperature upper limit. When the ambient temperature is higher than the optimum temperature and lower than the maximum operating temperature, the power control unit 102 determines the target surface temperature to be less than or equal to the target temperature upper limit and to be convex upward with respect to the ambient temperature. In other words, when the ambient temperature is higher than the optimum temperature and lower than the maximum operating temperature, the target surface temperature is a continuous function for the ambient temperature and is determined so as to exceed the percentage change in temperature from the optimum target temperature to the target temperature upper limit for the temperature change from the optimum temperature to the maximum operating temperature.

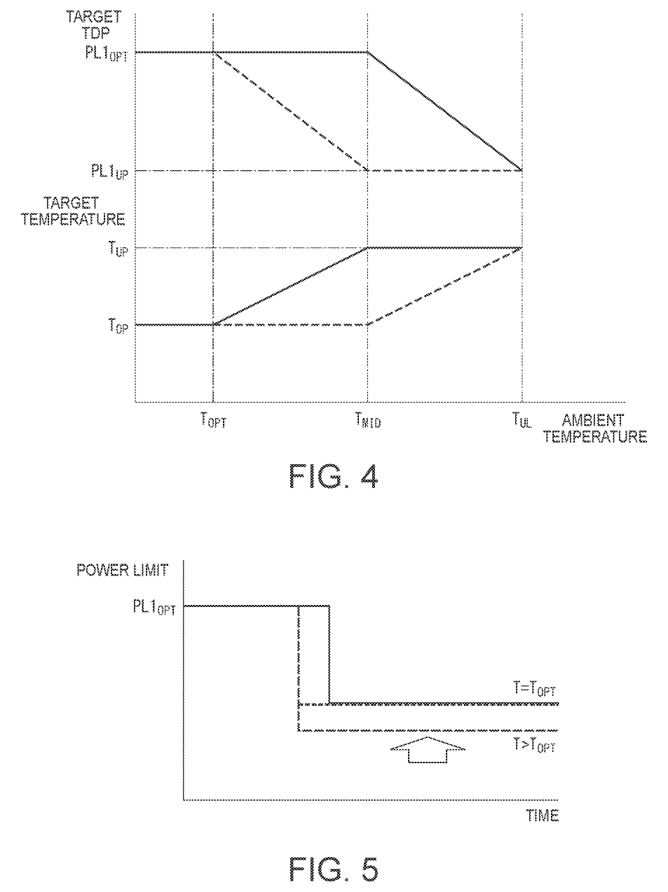

The following describes an example of setting the target TDP using FIG. 4. In the example in FIG. 4, optimum setting power PL1_{OPT}, optimum setting power PL1_{OPT}, and maximum temperature setting power PL1_{UL} are set as control points for three target TDPs, for optimum temperature T_{OPT}, intermediate temperature T_{MID}, and maximum operating temperature T_{UL}, respectively. When the ambient temperature T is within the range from the optimum temperature T_{OPT} to the intermediate temperature T_{MID}, the power control unit 102 determines the optimum setting power PL1_{OPT} as the target TDP. When the ambient temperature T is within the range from the intermediate temperature T_{MID} to the maximum operating temperature T_{UL}, the power control unit 102 determines the value PL1_{OPT}-a(T-T_{MID}), which is obtained by adding a power difference a(T-T_{MID}) obtained by multiplying the difference in temperature T-T_{MID} between the ambient temperature T and the intermediate temperature T_{MID} by a percentage change a to the optimum setting power PL1_{OPT}, as a target TDP (see the solid line). The percentage change a corresponds to a ratio PL1_{UL}-PL1_{OPT}/T_{UL}-T_{MID} of the change in power consumption PL1_{UL}-PL1_{OPT} from the optimum setting power PL1_{OPT} to the maximum temperature setting power PL1_{UL} to the change in temperature T_{UL}-T_{MID} from the intermediate temperature T_{MID} to the maximum operating temperature T_{UL}.

Therefore, when the ambient temperature is lower than the intermediate temperature T_{MID}, the optimum setting power PL1_{OPT} is set as the target TDP for the processor 11, and as the ambient temperature rises from the intermediate temperature T_{MID} to the maximum operating temperature T_{UL}, the target TDP set for the processor 11 is lowered from the optimum setting power PL1_{OPT} to the maximum temperature setting power PL1_{UL}. Therefore, even when the ambient temperature exceeds the optimum temperature T_{OPT}, the target TDP does not immediately decrease, and the processing power of the processor 11 is maintained. In addition, as the ambient temperature approaches the maximum operating temperature T_{UL}, the processing power of the processor 11 approaches the maximum temperature setting power PL1_{UL}, by which the temperature rise is suppressed in accordance with the decrease in power consumption.

The following describes an example of setting the target surface temperature using FIG. 4. In the example of FIG. 4, an optimum target temperature T_{OP}, a target temperature upper limit T_{UP}, and a target temperature upper limit T_{UP} are set as control points for three target surface temperatures, for the optimum temperature T_{OPT}, the intermediate temperature T_{MID}, and the maximum operating temperature T_{UL}. When the ambient temperature is within the range of the optimum temperature T_{OPT} to the intermediate temperature T_{MID}, the power control unit 102 determines, as a target surface temperature T_{target}, a value obtained by adding the difference in temperature b(T-T_{OPT}), which is obtained by multiplying the temperature difference T-T_{OPT} between the ambient temperature and the optimum temperature T_{OPT} by the percentage change b, to the optimum target temperature T_{OP}. The percentage change b corresponds to a ratio T_{UP}-T_{OP}/T_{MID}-T_{OPT} of the change in target surface temperature T_{UP}-T_{OP} from the optimum target temperature T_{OP} to the target temperature upper limit T_{UP} to the change in temperature T_{MID}-T_{OPT} from the optimum temperature T_{OP}_{T} to the intermediate temperature T_{MID}. When the ambient temperature is within the range from the intermediate temperature T_{MID} to the maximum operating temperature T_{UL}, the power control unit 102 determines the target temperature upper limit T_{UP} as the target surface temperature (see solid line).

Therefore, as the ambient temperature rises to the intermediate temperature T_{MID}, the target surface temperature rises more rapidly than the predetermined percentage change due to the temperature rise. Therefore, even when the ambient temperature exceeds the optimum temperature T_{OPT}, the temperature rise caused by heat generation is allowed, by which the power consumption of the processor 11 does not immediately decrease. In addition, when the ambient temperature exceeds the intermediate temperature T_{MID}, the target surface temperature is fixed at the target temperature upper limit T_{UP}. Thermal protection is achieved by suppressing further temperature rises.

Returning to FIG. 2, the operation of the EC 31 is described. The EC 31 notifies the host system 100 of the ambient temperature indicated by the temperature signal input from the ambient temperature sensor 352.

The EC 31 notifies the host system 100 of the ambient temperature indicated by the temperature signal input from the ambient temperature sensor 352.

The EC 31 controls the power supplied from the power circuit 33 to the processor 11 so as to meet the power, which is required for the power control mode, notified of by the host system 100.

For example, the register of the EC 31 is pre-configured with parameters (hereinafter, referred to as “power supply parameters”) related to power supplied for respective power control modes. The EC 31 refers to the register to identify the power supply parameter corresponding to the notified power control mode, and instructs the power circuit 33 to supply power based on the identified power supply parameter.

The EC 31 identifies the surface temperature indicated by a temperature signal input from the surface temperature sensor 353. When the surface temperature is higher than the predetermined target surface temperature, the EC 31 controls the operation of the heat dissipation fan 356 using the drive circuit 354 so that the surface temperature is equal to or lower than the target surface temperature. The EC may use the target surface temperature determined by the host system 100 to control the operation of the heat dissipation fan 356.

A drive parameter indicating the maximum output of the heat dissipation fan 356 for each power control mode may be set in the register of the EC 31. The larger the rated power in the power control mode, the larger the maximum output is set. In addition, a power control mode where the optimum setting power is less than or equal to the predetermined rated power may be set to “not operating.” The availability of operation may be indicated by a value indicating that information, or may be indicated by a value of zero or less as the maximum output. The EC 31 identifies the maximum output of the heat dissipation fan 356 on the basis of the power control mode notified of by the host system 100 by referring to the register. The EC 31 controls the operation of the heat dissipation fan 356 for the drive circuit 354 so as not to exceed the identified maximum output.

The following describes an example of power control parameters and drive parameters for respective operating modes. FIG. 3 is a diagram illustrating power control parameters and drive parameters according to one or more embodiments. In the example illustrated in FIG. 3, PL1, PL2, and the optimum target temperature, the maximum temperature setting power, and the target temperature upper limit are set for each of the three-step power control modes. There are three steps for the power control mode. The three-step power control modes are a performance mode, a balance mode, and an eco mode. PL1 is set to be the largest for the performance mode, and to be smaller in order of the performance mode, the balance mode, and the eco mode. PL2 may be smaller in order of the performance mode, the balance mode, and the eco mode, or may be equal between some or all of the power control modes. The maximum output is set to be the largest for the performance mode, and smaller in order of the performance mode, the balance mode, and the eco mode.

The target TDP setting based on the optimum setting power and the maximum temperature setting power is applied to the power control mode (for example, the performance mode) in which the rated power is equal to or greater than a predetermined value, and may not be applied to other power control modes. It is because, in other power control modes, the amount of heat generated by the processor 11 is less than the amount of heat dissipated from the heat dissipation fan 356 or from the chassis. For the same reason, in other power control modes, the target surface temperature based on the optimum target temperature and target temperature upper limit may not be applied, and a constant target surface temperature may be applied.

The following describes a comparative example, which is different from one or more embodiments of the present invention. In the comparative example, unlike one or more embodiments of the present invention, when the ambient temperature is higher than the optimum temperature but lower than the maximum operating temperature, the target TDP was determined to be less than or equal to the optimum setting power and to be convex downward with respect to the ambient temperature. Also, when the ambient temperature is higher than the optimum temperature but lower than the maximum operating temperature, the target surface temperature was determined to be greater than or equal to the optimum target temperature and to be convex downward with respect to the ambient temperature.

In the example in FIG. 4, when the ambient temperature rises from the optimum temperature T_{OPT} to the intermediate temperature T_{MID}, the target TDP increases from the optimum setting power PL1_{OPT} to the maximum temperature setting power PL1_{UL}. At this time, the target surface temperature is maintained at a constant optimum target temperature T_{OP}. When the ambient temperature rises from the intermediate temperature T_{MID} to the target temperature upper limit T_{UP}, the target TDP is maintained at constant maximum temperature setting power PL1_{UL}. At this time, the target surface temperature rises from the optimum target temperature T_{OP} to the target temperature upper limit T_{UP} (see the broken line).

Therefore, in the comparative example, power consumption is suppressed immediately after the ambient temperature exceeds the optimum temperature, thus the processor 11 cannot demonstrate more processing power that is able to be implemented than one or more embodiments.

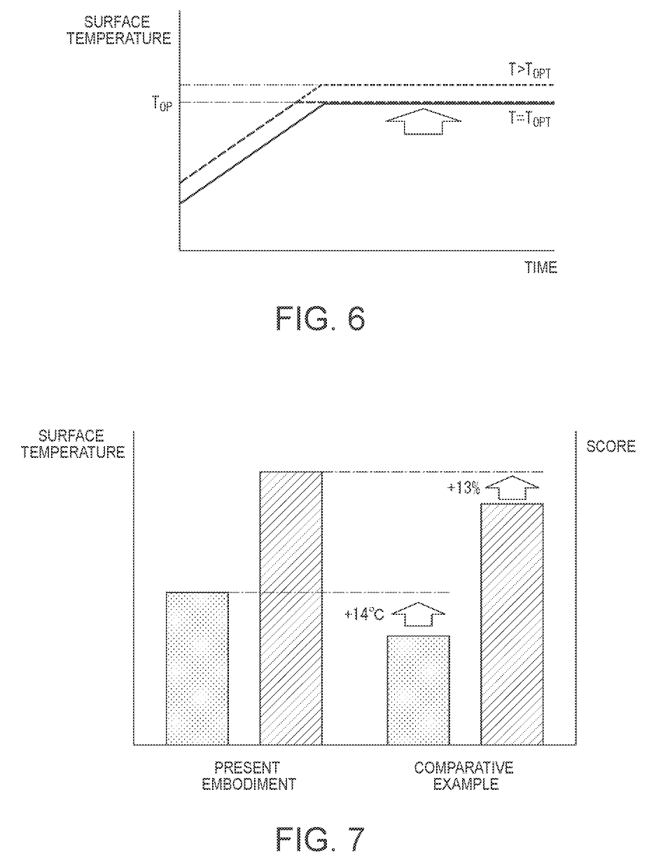

Subsequently, the operation examples of one or more embodiments and the comparative example are described using FIGS. 5 and 6. FIG. 5 illustrates the time variation of the target TDP. FIG. 6 illustrates the time variation of the target surface temperature.

In FIGS. 5 and 6, the solid line indicates a case where the ambient temperature T is equal to the optimum temperature T_{OPT}. In this case, for both one or more embodiments and the comparative example, the optimum target temperature T_{OP} is used as the target surface temperature. In both cases, when the surface temperature reaches the target surface temperature, the power limit set for the processor 11 is reduced from PL1 to the optimum setting power PL1_{OPT}.

A coarse broken line indicates a case where the ambient temperature T is higher than the optimum temperature T_{OPT} but lower than the intermediate temperature T_{MID} in the comparative example. A fine broken line indicates a case where the ambient temperature T is higher than the optimum temperature T_{OPT} but lower than the intermediate temperature T_{MID} in one or more embodiments.

In both one or more embodiments and the comparative example, the surface temperature reaches the target surface temperature earlier than when the ambient temperature T is equal to the optimum temperature T_{OPT}. In the comparative example, the target surface temperature is set to the optimum target temperature T_{OP}, whereas in one or more embodiments, the target surface temperature is set to a higher temperature, and therefore the time at which the surface temperature reaches the target surface temperature is later than the comparative example. In addition, in the comparative example, the target TDP was set to be less than the optimum setting power PL1_{OPT}, while in one or more embodiments, the target TDP was maintained to be equal to the optimum setting power PL1_{OPT}.

Therefore, in a situation where the ambient temperature exceeds the optimum temperature, one or more embodiments allow the surface temperature to exceed the optimum target temperature T_{OP}, thereby enabling power consumption to be increased.

The following describes an example of performing a benchmark test. The benchmark test was performed for both one or more embodiments and the comparative example. In the benchmark test, the same benchmark software was executed on the same hardware for both one or more embodiments and the comparative example. The benchmark software in question causes a continuous high load, such as 3D video editing or the like. The optimum temperature and the maximum operating temperature were set to 25°C and 35°C, respectively, and the average surface temperature and a score value obtained by execution were acquired in an environment with an ambient temperature of 30°C. According to FIG. 7, in one or more embodiments, the surface temperature was 49.8°C and the score was 8799. In contrast, in the comparative example, the surface temperature was 48.4°C and the score was 7779. Therefore, according to one or more embodiments, the surface temperature increased by 1.4°C, but the score increased by 13%. Therefrom, according to one or more embodiments, performance is able to be increased while allowing for an increase in the surface temperature to the extent that thermal protection is able to be achieved.

In the example of FIG. 4, the target TDP for the intermediate temperature T_{MID} is set as the optimum setting power PL1_{OPT}, but the target TDP for the intermediate temperature T_{MID} (hereinafter, the target TDP is referred to as “third TDP”) PL1₃ only needs to be higher than the intermediate TDP PL1_{MID} and lower than or equal to the optimum setting power PL1_{OPT}. The intermediate TDP PL1_{MID} corresponds to the TDP obtained by internally dividing the optimum setting power PL1_{OPT} and the maximum temperature setting power PL1_{UL} by the difference in temperature T_{MID}-T_{OPT} between the optimum temperature T_{OPT} and the intermediate temperature T_{MID}, and by the difference in temperature T_{UL}-T_{MID} between the intermediate temperature T_{MID} and the maximum operating temperature T_{UL}.

In the case where the ambient temperature T is higher than the optimum temperature T_{OPT} but lower than the intermediate temperature T_{MID}, the power control unit 102 may define the target TDP as PL1_{OPT}+(T-T_{OPT})*(PL1_{MID}-PL1₃)/(T_{MID}-T_{OPT}). In the case where the ambient temperature T is higher than the intermediate temperature T_{MID} and lower than the maximum operating temperature T_{UL}, the power control unit 102 may define the target TDP as PL1₃+(T-T_{MID})*(PL1_{UL}-PL1₃)/(T_{UL}-T_{MID}).

In addition, the target surface temperature (hereinafter, referred to as the “third surface temperature”) T₃ for the intermediate temperature T_{MID} may be higher than the intermediate target temperature and lower than or equal to the target temperature upper limit T_{UP}. The intermediate target temperature T_{MIDT} corresponds to the surface temperature obtained by internally dividing the optimum target temperature T_{OP} and the target temperature upper limit T_{UP} by the difference in temperature T_{MID}-T_{OPT} between the optimum temperature T_{OPT} and the intermediate temperature T_{MID} and the difference in temperature T_{UL}-T_{MID} between the intermediate temperature T_{MID} and the maximum operating temperature T_{UL}.

In the case where the ambient temperature T is higher than the optimum temperature T_{OPT} but lower than the intermediate temperature T_{MID}, the power control unit 102 may define the target surface temperature as T_{OP}+(T-T_{OPT})*(T₃-T_{OP})/(T_{MID}-T_{OPT}). In the case where the ambient temperature T is higher than the intermediate temperature T_{MID} and lower than the maximum operating temperature T_{UL}, the power control unit 102 may define the target surface temperature as T₃+(T-T_{MID})*(T_{UP}-T₃)/(T_{UL}-T_{MID}).

As described above, the information processing apparatus 1 according to one or more embodiments has the temperature sensor 352 that detects the ambient temperature and the computer system that controls power consumption on the basis of thermal design power corresponding to the ambient temperature (for example, the host system 100). There are preset first thermal design power (for example, the optimum setting power PL1_{OPT}), which is thermal design power corresponding to the optimum temperature T_{OPT}, and second thermal design power (for example, the maximum temperature setting power PL1_{UL}), which is the thermal design power corresponding to the upper limit of the operating temperature (for example, the maximum operating temperature T_{UL}) so as to be less than the first thermal design power. When the ambient temperature is higher than the optimum temperature and lower than the upper limit of the operating temperature, the computer system determines thermal design power (for example, the target TDP) corresponding to the ambient temperature that is less than or equal to the first thermal design power and also convex upward with respect to the ambient temperature.

According to this configuration, the thermal design power corresponding to the ambient temperature is determined so that, even when the surface temperature exceeds the target surface temperature, the thermal design power does not deviate greatly from the first thermal design power. This enables increase in performance while allowing temperature rise within the range where thermal protection is provided under ambient temperatures close to the optimum temperature.

In addition, in the information processing apparatus 1 according to one or more embodiments, an intermediate temperature (for example, T_{MID}) higher than the optimum temperature and lower than the upper limit of the operating temperature is predetermined, and third thermal design power (for example, the third TDP PL1₃), which is the thermal design power corresponding to the intermediate temperature, is predetermined so that the percentage change from the first thermal design power corresponding to the optimum temperature is less than the percentage change from the first thermal design power corresponding to the optimum temperature to the second thermal design power, and when the ambient temperature is higher than the optimum temperature and lower than the intermediate temperature, the computer system may subtract the product of the percentage change in difference between the first thermal design power and the third thermal design power for the difference in temperature between the optimum temperature and the intermediate temperature and the difference in temperature between the optimum temperature and the intermediate temperature from the first thermal design power to determine the thermal design power for the ambient temperature, and when the ambient temperature is higher than the intermediate temperature and lower than the upper limit of the operating temperature, the computer system may subtract the product of the percentage change in difference between the third thermal design power and the second thermal design power for the difference in temperature between the intermediate temperature and the upper limit of the operating temperature and the difference in temperature between the intermediate temperature and the ambient temperature from the third thermal design power to determine the thermal design power for the ambient temperature. Note that the third thermal design power may be equal to the first thermal design power.

According to this configuration, when the ambient temperature is higher than the optimum temperature and lower than the upper limit of the operating temperature, only setting the third thermal design power corresponding to the intermediate temperature enables the thermal design power for the ambient temperature to be determined by performing simple multiplication and addition operations. This inhibits the load associated with setting the thermal design power from being increased significantly.

In addition, the information processing apparatus 1 according to one or more embodiments may further include a second temperature sensor (for example, the temperature sensor 353) that is a temperature sensor that detects a surface temperature, and a first target surface temperature (for example, T_{OP}) that is a target surface temperature corresponding to an optimum temperature and a second target surface temperature (for example, T_{UP}) that is a target surface temperature corresponding to an upper limit of an operating temperature may be predetermined to be higher than the first target surface temperature. When the ambient temperature is higher than the optimum temperature and lower than the upper limit of the operating temperature, the computer system may determine the target surface temperature (for example, the target TDP) to be less than or equal to the second target surface temperature and to be convex upward with respect to the ambient temperature.

According to this configuration, when the surface temperature exceeds the target surface temperature, the target surface temperature corresponding to the ambient temperature is determined so as to deviate from the first thermal design power. This enables performance to be increased while allowing temperature rise under ambient temperatures close to the optimum temperature within the range where thermal protection is provided.

In addition, in the information processing apparatus 1 according to one or more embodiments, an intermediate temperature (for example, T_{MID}) higher than the optimum temperature and lower than the upper limit of the operating temperature is predetermined, and the third target surface temperature (for example, the third surface temperature T₃) that is a target surface temperature corresponding to the intermediate temperature may be predetermined so that the percentage change from the first target surface temperature corresponding to the optimum temperature is greater than the percentage change from the first target surface temperature corresponding to the optimum temperature to the second target surface temperature corresponding to the upper limit of the operating temperature.

When the ambient temperature is higher than the optimum temperature and lower than the intermediate temperature, the computer system adds a product of the percentage change in difference between the first target surface temperature and the third target surface temperature for a difference in temperature between the optimum temperature and the intermediate temperature and a difference in temperature between the optimum temperature and the ambient temperature to the first target surface temperature to determine the target surface temperature for the ambient temperature, and when the ambient temperature is higher than the intermediate temperature and lower than the upper limit of the operating temperature, the computer system adds the product of the percentage change in difference between the third target surface temperature and the second target surface temperature for the difference in temperature between the intermediate temperature and the upper limit of the operating temperature and the difference in temperature between the intermediate temperature and the ambient temperature to the third target surface temperature to determine the target surface temperature for the ambient temperature.

Note that the third target surface temperature may be equal to the second target surface temperature.

According to this configuration, when the ambient temperature is higher than the optimum temperature but lower than the upper limit of the operating temperature, only setting the third target surface temperature corresponding to the intermediate temperature enables the target surface temperature for the ambient temperature to be determined by performing simple multiplication and addition operations. This inhibits the load associated with setting the target surface temperature from being increased significantly.

In addition, in the information processing apparatus 1 according to one or more embodiments, the computer system operates in any one of multiple-step operating modes with different rated power (in other words, the power control modes), and when the computer system operates in an operating mode where the rated power is greater than the predetermined reference power (for example, the performance mode) and the ambient temperature is higher than the optimum temperature and lower than the upper limit of the operating temperature, the computer system may determine the thermal design power to be less than or equal to the first thermal design power and to be convex upward with respect to the ambient temperature.

According to this configuration, when operating in an environment where the ambient temperature is higher than the optimum temperature in an operating mode with high rated power, the computer system is able to meet expectations for the use of that operating mode by increasing performance while allowing temperature rise to the extent that thermal protection is provided.

Embodiments of the present disclosure have been described in detail with reference to the drawings, but the specific configuration is not limited to the embodiments described above, and also includes designs and the like that do not deviate from the gist of the present disclosure. The individual configurations described in the above embodiments may be combined arbitrarily as long as there is no contradiction, and some configurations may be omitted.

For example, the drive circuit 354 and the heat dissipation fan 356 may be omitted from the information processing apparatus 1. In that case, the processing related to the setting of the drive parameter described above is omitted. In addition, the information processing apparatus 1 may have a refrigerant circulation circuit instead of the drive circuit 354 and the heat dissipation fan 356, or together with the drive circuit 354 and the heat dissipation fan 356. In that case, the circulating volume of the refrigerant circulation circuit may be controlled with the same relationship as the power consumption of the host system 100 and the operating volume of the heat dissipation fan 356, instead of or together with the operating volume of the heat dissipation fan 356.

In addition, the operating mode of the host system 100 is not limited to three steps, and may be two or fewer steps or four or more steps. In addition, the setting method of the TDP and target surface temperature according to one or more embodiments is not limited to a one-step operating mode with the highest rated power, but may be applied to two-or-more-step operating modes.

The above description has been made for a case where the target TDP and target surface temperature are expressed mainly as a linear function of the ambient temperature, but the function is not limited thereto. Higher-order functions of second order or higher, or other functions may be used as long as the function is able to uniquely give the target TDP or target surface temperature with respect to the ambient temperature.

What is claimed is:

1. An information processing apparatus comprising:
a temperature sensor that detects an ambient temperature; and
a computer system that controls power consumption based on thermal design power corresponding to the ambient temperature, wherein:
there are predetermined first thermal design power that is thermal design power corresponding to an optimum temperature, and second thermal design power that is thermal design power corresponding to an upper limit of an operating temperature to be less than the first thermal design power; and
when the ambient temperature is higher than the optimum temperature and lower than the upper limit of the operating temperature, the computer system determines the thermal design power to be less than or equal to the first thermal design power and to be convex upward with respect to the ambient temperature.

2. The information processing apparatus according to claim 1, wherein:
an intermediate temperature higher than the optimum temperature and lower than the upper limit of the operating temperature is predetermined;
third thermal design power that is thermal design power corresponding to the intermediate temperature is predetermined so that a percentage change from the first thermal design power corresponding to the optimum temperature is less than a percentage change from the first thermal design power corresponding to the optimum temperature to the second thermal design power;
when the ambient temperature is higher than the optimum temperature and lower than the intermediate temperature, the computer system subtracts a product of a percentage change in difference between the first thermal design power and the third thermal design power for a difference in temperature between the optimum temperature and the ambient temperature and the difference in temperature between the optimum temperature and the ambient temperature from the first thermal design power to determine the thermal design power for the ambient temperature; and
when the ambient temperature is higher than the intermediate temperature and lower than the upper limit of the operating temperature, the computer system subtracts a product of a percentage change in difference between the third thermal design power and the second thermal design power for a difference in temperature between the intermediate temperature and the upper limit of the operating temperature and a difference in temperature between the intermediate temperature and the ambient temperature from the third thermal design power to determine the thermal design power for the ambient temperature.

3. The information processing apparatus according to claim 2, wherein the third thermal design power is equal to the first thermal design power.

4. The information processing apparatus according to claim 1, further comprising a second temperature sensor that detects a surface temperature, wherein:
there are predetermined a first target surface temperature that is a target surface temperature corresponding to the optimum temperature and a second target surface temperature that is a target surface temperature corresponding to the upper limit of the operating temperature to be higher than the first target surface temperature; and
the computer system determines the target surface temperature to be less than or equal to the second target surface temperature and to be convex upward with respect to the ambient temperature when the ambient temperature is higher than the optimum temperature and lower than the upper limit of the operating temperature.

5. The information processing apparatus according to claim 4, wherein:
an intermediate temperature higher than the optimum temperature and lower than the upper limit of the operating temperature is predetermined;
the third target surface temperature that is a target surface temperature corresponding to the intermediate temperature is predetermined so that the percentage change from the first target surface temperature corresponding to the optimum temperature is greater than the percentage change from the first target surface temperature corresponding to the optimum temperature to the second target surface temperature corresponding to the upper limit of the operating temperature;
the computer system adds a product of a percentage change in difference between the first target surface temperature and the third target surface temperature for a difference in temperature between the optimum temperature and the intermediate temperature and a difference in temperature between the optimum temperature and the ambient temperature to the first target surface temperature to determine the target surface temperature for the ambient temperature, when the ambient temperature is higher than the optimum temperature and lower than the intermediate temperature; and
the computer system adds a product of a percentage change in difference between the third target surface temperature and the second target surface temperature for a difference in temperature between the intermediate temperature and the upper limit of the operating temperature and a difference in temperature between the intermediate temperature and the ambient temperature to the third target surface temperature to determine the target surface temperature for the ambient temperature, when the ambient temperature is higher than the intermediate temperature and lower than the upper limit of the operating temperature.

6. The information processing apparatus according to claim 5, wherein the third target surface temperature is equal to the second target surface temperature.

7. The information processing apparatus according to claim 1, wherein:
the computer system operates in any one of multiple-step operating modes with different rated power; and
the computer system determines the thermal design power to be less than or equal to the first thermal design power and to be convex upward with respect to the ambient temperature, when operating in an operating mode where the rated power is greater than predetermined reference power and the ambient temperature is higher than the optimum temperature and lower than the upper limit of the operating temperature.

8. A control method in an information processing apparatus including a temperature sensor that detects an ambient temperature and a computer system that controls power consumption based on thermal design power corresponding to the ambient temperature, wherein:
there are predetermined first thermal design power that is thermal design power corresponding to an optimum temperature and second thermal design power that is thermal design power corresponding to an upper limit of an operating temperature to be less than the first thermal design power; and
when the ambient temperature is higher than the optimum temperature and lower than the upper limit of the operating temperature, the thermal design power is determined to be less than or equal to the first thermal design power and to be convex upward with respect to the ambient temperature.
